(19) United States
(12) Patent Application Publication
(10) Pub. No.: US 2020/0302393 A1
(43) Pub. Date: Sep. 24, 2020

(54) MACHINE LEARNING FOR CASE MANAGEMENT INFORMATION GENERATION

(71) Applicant: ServiceNow, Inc., Santa Clara, CA (US)

(72) Inventors: Sanjay Kumar Gupta, Saratoga, CA (US); Rahul Guha, San Jose, CA (US); Abhranil Naha, Santa Clara, CA (US); Harish Kumar Balachandra Bellamane, San Jose, CA (US); Vamsi Krishna Soma, Sunnyvale, CA (US)

(21) Appl. No.: 16/356,994

(22) Filed: Mar. 18, 2019

(51) Int. Cl. G06Q 10/10; G06N 20/00

(52) U.S. Cl. CPC G06Q 10/10; G06N 20/00

(57) ABSTRACT

The present disclosure is related to a case management application that may be used by a user to open service cases. The user may enter certain input information in a field of the service case and the case management application may automatically identify output information based on the input information. The case management application may fill or populate other fields of the service case with the identified output information. The case management application may use trained machine learning routines to identify the output information based on input information. A designer of the case management application may configure the case management application. For example, the designer may select the trained machine learning routines that are accessed by the case management application to adjust how the case management application identifies output information.

### BACKGROUND

The present disclosure relates generally to case management and, specifically, to using machine learning to facilitate creating service cases.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

Certain service events may occur in the context of such systems, which may impact a performance of certain devices and/or networks. Service cases may be opened to manage and address different service events, such as by providing information for the service events to facilitate addressing such service events. However, the steps associated with opening each service case may be inefficient and/or tedious in conventional approaches.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relates to a use and design of a case management application. A user may utilize the case management application to open a service case to manage a certain service event. The user may provide information into fields of the service case via the case management application. The case management application may receive input information provided by the user in one of the fields of the service case, and the case management application may identify output information to fill or populate other fields of the service case. A designer of the case management application may configure how the case management application identifies the output information. For example, the case management application may access trained machine learning routines to identify relevant output information based on the input information. The designer may select the trained machine learning routines that are accessed by the case management application to adjust how the case management application identifies the output information based on the input information.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 is a schematic view of an embodiment of a training system that may be used to generate trained machine learning routines or solutions that may be used by a case management application, in accordance with aspects of the present disclosure;

FIG. 6 is an embodiment of a definition interface that may be accessed by a designer of a case management application, in which the definition interface may display a plurality of trained models, in accordance with aspects of the present disclosure;

FIG. 7 is an embodiment of a configuration interface that may be accessed by a designer of a case management application to manage trained machine learning routines that are accessible to the case management application, in accordance with aspects of the present disclosure;

FIG. 8 is an embodiment of a detail interface that may be accessed by a designer of a case management application, in which the detail interface may display detailed information associated with a selected routine record, in accordance with aspects of the present disclosure;

FIG. 9 is an embodiment of a script interface that may be accessed by a designer of a case management application to manage trained machine learning routines that are accessed by the case management application, in accordance with aspects of the present disclosure;

FIG. 10 is an embodiment of a property interface that may be accessed by a designer of a case management application to configure the case management application, in accordance with aspects of the present disclosure;

FIG. 11 is an embodiment of a flowchart of a method for a case management application to generate output information based on input information, in accordance with aspects of the present disclosure;

FIG. 12 is an embodiment of a user interface that may be accessed by a user of a case management application to open a service case, in accordance with aspects of the present disclosure;

FIG. 13 is an embodiment of a user interface that may be accessed by a user of a case management application, in which the case management application has automatically populated certain fields of the user interface with output information, in accordance with aspects of the present disclosure;

FIG. 14 is an embodiment of a user interface that may be accessed by a user of a case management application, in which the case management application is not able to identify output information for a certain field of the user interface, in accordance with aspects of the present disclosure; and

FIG. 15 is an embodiment of a user interface that may be accessed by a user of a case management application, in which the case management application does not automatically populate a certain field of the user interface with output information, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

A case management application may be used to manage and address service events. A user (e.g., a customer service agent) of the case management application may open a service case for each service event. In each service case, the user may provide information pertaining to the associated service event, such as within a plurality of fields of the service case. The information may describe the service event such that other users may address the associated service event based on the information. Providing information for each service event may be tedious and/or inefficient. For example, different service cases associated with similar service events may share common information. However, the user may still be required to manually provide information for each service case and, therefore, may spend an excessive amount of time creating service cases.

Thus, a case management application configured to generate information for a service case automatically may reduce an amount of time the user spends to create the service case. For example, the case management application may receive input information entered by the user into one of the fields of the service case, and the case management application may identify output information for one or more fields based on the input information. The case management application may then automatically populate or fill certain fields of the service case with the output information. In some embodiments, the case management application may access trained machine learning routines trained using paired input and ground truth output data to enable the case management application to generate output information based on the input information. By automatically providing output information for one or more fields of the service case, the case management application may enable the user to avoid filling certain information of the service case manually. Thus, the user may create service cases more quickly.

A designer of the case management application may be able to configure the case management application, such as via a design application. For example, the designer may select which trained machine learning routines are accessed by the case management application and/or manage the training of such machine learning routines. In this manner, the designer may configure or customize the case management application to adjust how the output information is identified based on the input information.

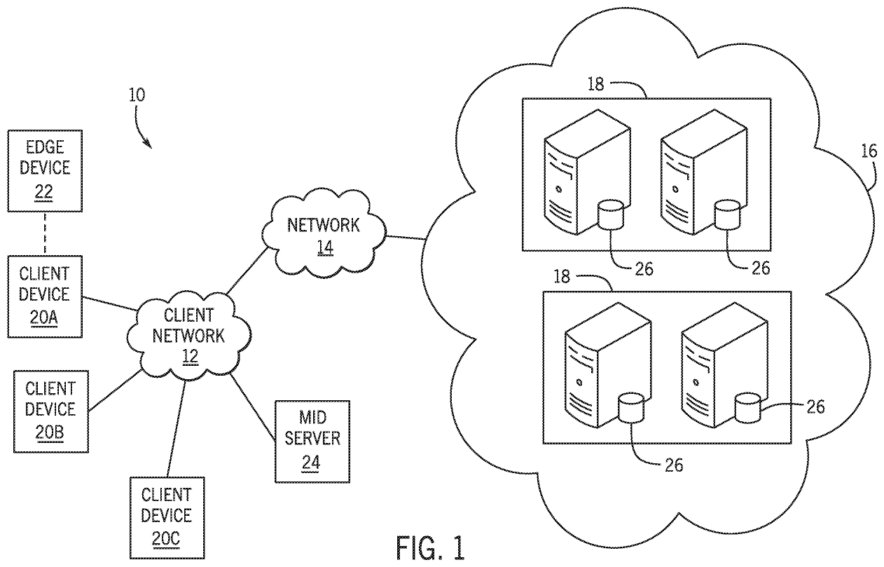

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

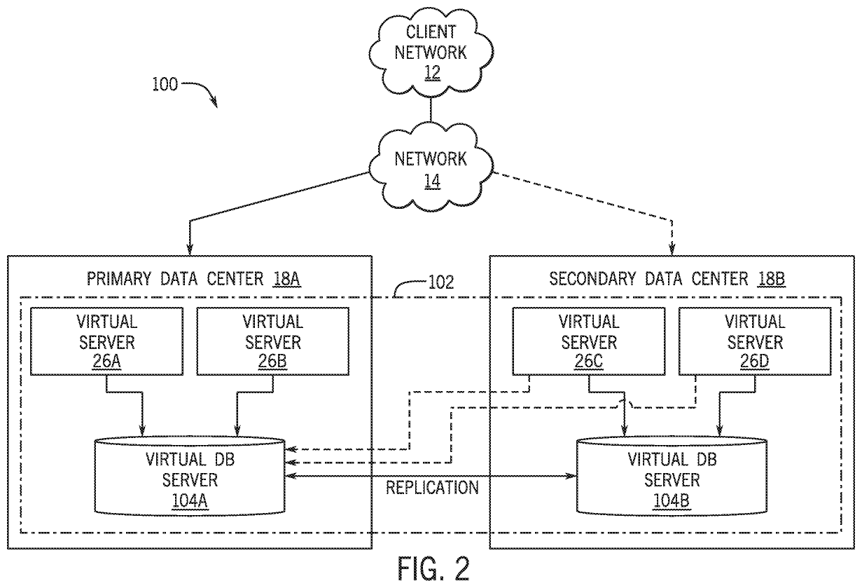

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

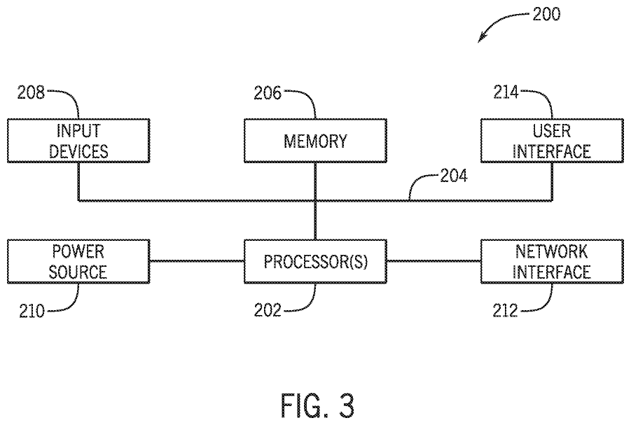

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

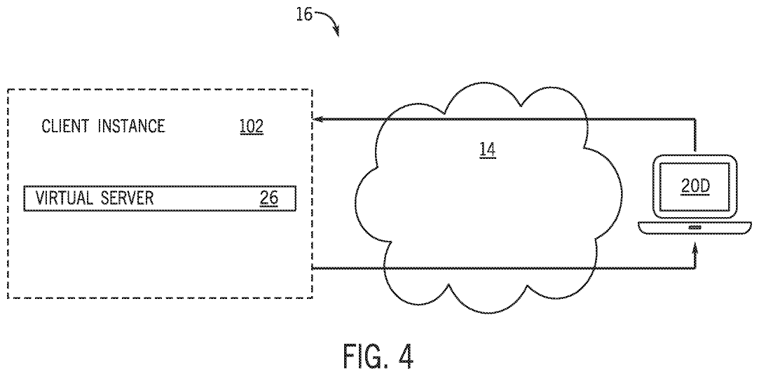

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20D via the network 14 to provide a user interface to network applications executing within the client instance 102 (e.g., via a web browser of the client device 20D). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20D, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As discussed herein, the client instance 102 may be implemented so as to support access to a case management application. The case management application may be used to facilitate creating service cases, such as by generating output information to populate certain fields associated with the service cases based on input information from a user. In some embodiments, the case management application may be a cloud-based application running on the cloud-based platform 16 that is accessed via the client device 20. For example, the case management application may be executed on an application server running on the cloud based platform 16 and may access trained machine learning routines stored on the cloud-based platform 16. The trained machine learning routines may be trained so as to generate relevant output information for one or more service case fields in response to limited information, such as a short problem description or summary.

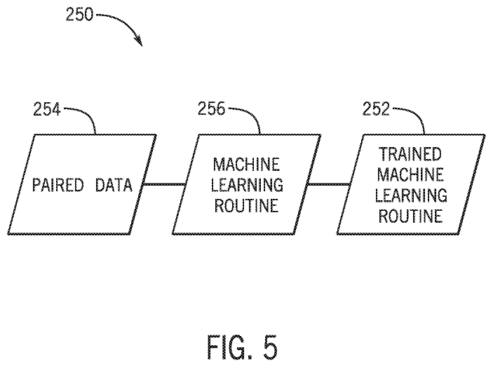

FIG. 5 is a schematic view of an embodiment of a training system 250 that may be used to generate trained machine learning routines or solutions 252 that may be used by a case management application. In the illustrated embodiment, paired training data 254 (e.g., paired inputs and ground truth outputs) is provided as an input to a machine learning routine. Such paired training data 254 typically represent pairs of known inputs and corresponding outputs (such as for a given field of a case management database) such that the machine learning routine can generate weights or other terms or functions to derive relationships between a given output and input.

The paired training data 254 may be provided as an input to an existing machine learning routine or solution 256. The machine learning routine 256 may be an untrained routine that has not previously been trained with paired training data 254 or may be a previously trained routine that is receiving supplemental training with additional paired training data 254. Implementing the paired training data 254 to the machine learning routine 256 results in a trained machine learning routine 252. The trained machine learning routine 252 may be readily used or accessed by the case management application and provides an output for one or more case management fields in response to an input data string (e.g., a brief problem description or summary). In certain embodiments, each existing trained machine learning routine 252 may be re-trained with additional paired training data 254. That is, each trained machine learning routine 252 may receive additional paired training data 254, such as to improve performance (e.g., reduce a number of incorrect or unsuitable output field response). The re-trained machine learning routine may then be used or accessed by the case management application.

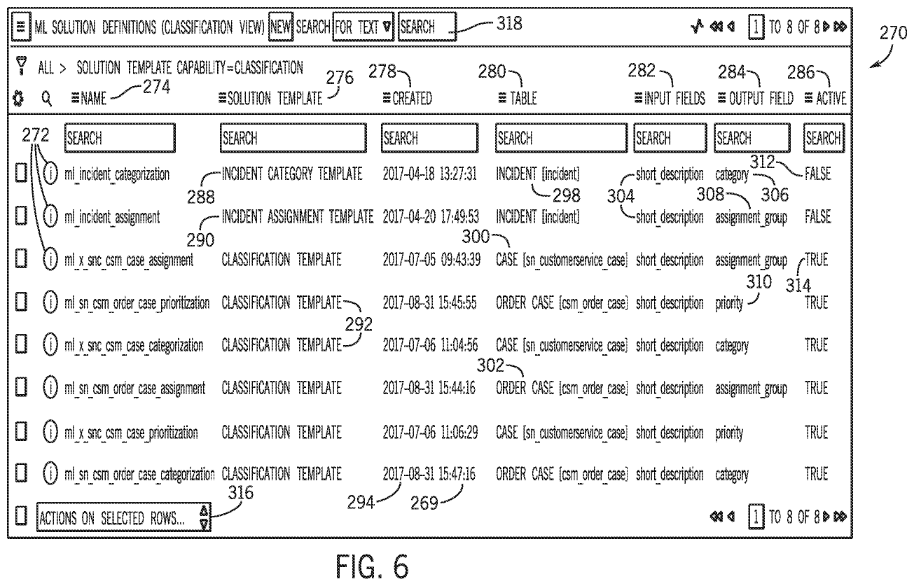

FIG. 6 is an embodiment of a definition interface 270 that may be accessed by a designer (e.g., via a design application) of the case management application. The definition interface 270 may include all available trained models 272 that may be accessed by a particular case management application. As shown in FIG. 6, the definition interface 270 includes eight trained models 272 and information associated with each trained model 272. Although this disclosure primarily refers to each trained model 272 as having a respective trained machine learning routine 252, it should be noted that each trained model 272 may alternatively include more than one trained machine learning routine 252. However, in alternative embodiments, the definition interface 270 may have any suitable number of trained models 272 available based on the number of created trained models 272 available to be accessed by the case management application.

In the illustrated embodiment, the definition interface 270 has a plurality of fields, including a name field 274, a solution template field 276, a created field 278, a table field 280, an input field 282, an output field 284, and an active field 286. Additional or alternative fields may also be included in the definition interface 270. Each field may include respective information associated with each trained model 272. For example, the name field 274 may include a respective name of each trained model 272 and the solution template field 276 may include a classification or grouping associated with each trained model 272. As illustrated in FIG. 6, possible solution template fields 276 may include an incident category template entry 288, an incident assignment template entry 290, and a classification template entry 292, but the solution template field 276 may include additional or alternative classifications by which the trained model 272 may be categorized. The created field 278 may include information associated with when the trained model 272 was created, such as a date entry 294 (e.g., year, month, day) and time entry 296. The table field 280 may include information related to the type of created service case that may access the trained models 272. As illustrated in FIG. 6, one of the trained models 272 may be accessed by a created incident entry 298, a created case entry 300, or a created order case entry 302, but each trained model 272 may be accessed by another type of service case.

Moreover, the input field 282 includes the type of input information that each trained model 272 may be configured to receive as an input. In the illustrated implementation, each trained model 272 is associated with a short description entry 304 in the input field 282. In additional or alternative implementations, the input field 282 may include other types of input information that each trained machine learning routine 252 of the trained models 272 may use to identify output information. The output field 284 includes the type of output information (e.g., case management table field or fields) that each trained machine learning routine 252 of the trained models is trained to generate based on the input information, including a category entry 306, an assignment group entry 308, a priority entry 310, or another suitable type of output information. As an example, if the input field 282 corresponds to a short description entry 304 and the output field 284 includes the category 306, the particular trained model 272 generates a category field value in response to an input short description of a problem. In other words, the trained model 272 may use input information entered in the short description of an opened service case to identify output information to be entered into the category of the same opened service case. Finally, each active field 286 may include a false entry 312, indicating that the particular trained model 272 is not active and is not being accessed by the case management application, or a true entry 314, indicating that the particular trained model 272 is active and is being accessed by the case management application.

In some embodiments, the designer may be able to perform certain actions to the trained models 272 on the definition interface 270. As an example, the definition interface 270 may include a selectable action icon 316. The designer may select the action icon 316 and perform certain actions, such as enabling one of the trained models 272 to be accessed by the case management application, disabling one of the trained models 272 from being accessed by the case management application, adding another trained model 272 to the definition interface 270, removing a particular trained model 272 from the definition interface 270, another suitable action, or any combination thereof. Furthermore, the definition interface 270 may include a search icon 318, which the designer may use to query or search for a particular ML routine, such as based on any of the fields illustrated in FIG. 6.

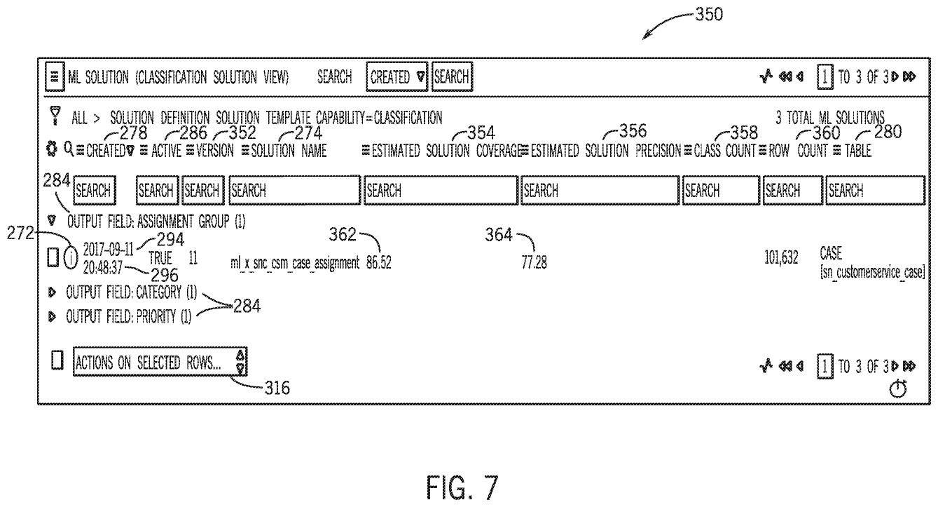

FIG. 7 illustrates an embodiment of a configuration interface 350 that may be accessed by the designer via the design application, in which the designer may use the configuration interface 350 to manage trained models 272 that are currently accessed by the case management application. To this end, the configuration interface 350 may include the active trained models 272. In some embodiments, each trained model 272 may be grouped based on a particular field, such as one of the fields described in FIG. 6. In the illustrated embodiment, the trained models 272 are grouped based on the output field 284, but in additional or alternative embodiments, the trained models 272 may be grouped based on any other field.

As shown in FIG. 7, the configuration interface 350 includes a plurality of fields that each include information associated with the respective trained models 272. For example, the plurality of fields include the created field 278 indicating when the associated trained model 272 was created, the active field 286, a version field 352, the name field 274, a coverage field 354, a precision field 356, a class field 358, a row field 360, and the table field 280. Additionally or alternatively, other suitable fields may be displayed on the configuration interface 350.

The version field 352 may indicate the iteration of a particular trained model 272. For example, if the trained model 272 has been modified multiple times, the version field 352 indicates which modified version of the trained model 272 is in effect. The coverage field 354 may be associated with a coverage percentage 362, or a percentage of output information identified using the associated trained model 272 relative to a total amount of input information received from the user. In this manner, the coverage field 354 may indicate a probability that the associated trained model 272 is able to identify output information based on input information. Moreover, the precision field 356 may be associated with a precision percentage 364, or a percentage that identified output information is not changed (e.g., overridden) by the user. That is, the precision field 356 may indicate a probability that identified output information is accurate.

To obtain the coverage percentage 362 and precision percentage 364, data, such as data associated with a quantity of input information, a quantity of output information, and/or a quantity of output information changed by the user, may be continuously monitored to obtain the respective information associated with the coverage field 354 and the precision field 356. In certain embodiments, the coverage percentage 362 and/or the precision percentage 364 may be associated with a time interval. For example, the designer may specify displaying the coverage percentage 362 and/or the precision percentage 364 pertaining to the previous day, week, month, and so forth. The corresponding coverage percentage 362 and/or the precision percentage 364 may generally indicate how well the associated trained model 272 is functioning to generate useful or suitable output information. By way of example, if the coverage percentage 362 and/or the precision percentage 364 is below a certain threshold (e.g., 60%, 50%, or a value below 40%), a notification may be sent, such as to indicate that the associated trained model 272 should not be used and/or the associated trained model 272 should be modified to improve identifying output information.

In addition, the class field 358 and the row field 360 may each indicate a quantity of paired training data 254 associated with the trained models 272. By way of example, the class field 358 may indicate a quantity of different types of paired training data 254, such as a field, topic, or grouping represented by the paired training data 254. Moreover, the row field 360 may indicate a total number of entered pairs. That is, each input information (e.g., a keyword entered by the user) and output information (e.g., a particular category) may considered a pair, and the row field 360 may indicate the number of pairs of input information and output information.

The configuration interface 350 may also include the selectable action icon 316 to enable the designer to perform certain actions. For example, the selectable action icon 316 may enable the designer to remove a particular trained model 272 from being accessed by the case management application, to view other information associated with each trained model 272, and so forth. Moreover, each trained model 272 may be selectable via the configuration interface 350. As an example, the user may select the date entry 294 and/or time entry 296, which may enable the user to view detailed information associated with a selected trained model 272.

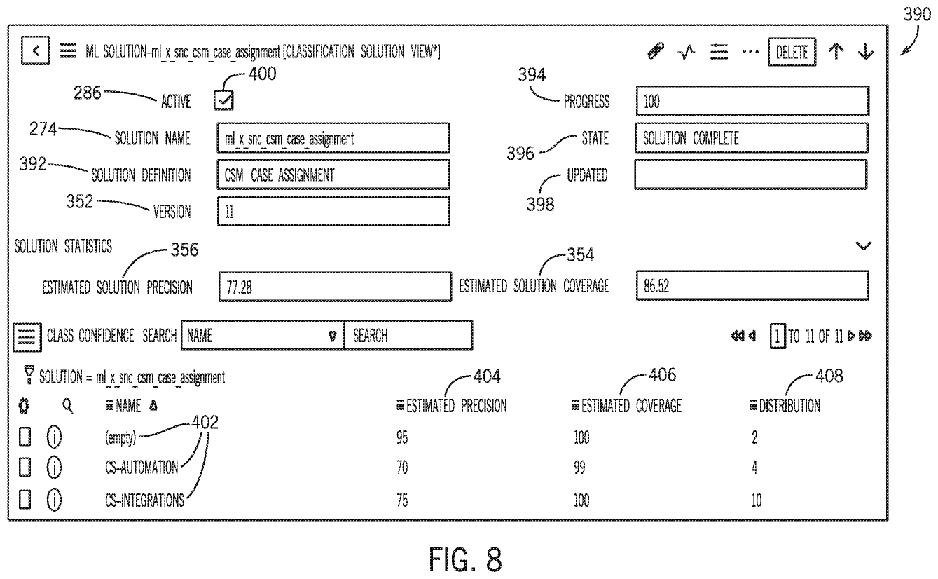

FIG. 8 illustrates an embodiment of a detail interface 390 accessed by the designer, in which the detail interface 390 may display additional details of a selected trained model 272. The detail interface 390 may be displayed upon a selection of a selected trained model 272 by the designer. The detail interface 390 may show the active field 286, the coverage field 354, and/or the precision field 356. The detail interface 390 may additionally have a definition field 392 indicative of the type of output information to be identified by the associated trained model 272. That is, the definition field 392 may describe the particular field(s) for which the machine learning routine 252 may generate output information. Moreover, the detail interface 390 may include a progress field 394, a state field 396, and/or an updated field 398. The progress field 394 may indicate a percentage of completion associated with the trained model 272, such as a percentage of desired paired training data 254 that has been successfully implemented to the trained model 272, and/or a completion of another configuration of the trained model 272. The updated field 398 may indicate when (e.g., date, time) the information of the trained model 272 was previously updated.

The designer may be able change certain information associated with the trained model 272 via the detail interface 390. For example, the designer may override the name of the trained model 272 associated with the name field 274, the definition associated with the definition field 392, and so forth. Moreover, the designer may be able to adjust whether or not the associated trained model 272 is active or inactive, such as by a checkbox 400 at the active field 286.

Furthermore, the detail interface 390 may show information associated with classes or types of paired training data 254. In certain embodiments, the detail interface 390 may include class records 402 corresponding to a respective class of paired training data 254. In the illustrated embodiment, the class records 402 include automation and integration, but in additional or alternative embodiments, the class records 402 may include other classes. Each class may include a plurality, a set, or a collection of associated paired data 254 pertaining to the class. In some implementations, the designer may select which class records 402 may be included by a particular trained model 272. In other words, the designer may determine which plurality of paired training data 254 may be implemented in each associated trained model 272. As an example, the designer may select particular paired data 254 based on a possible implementation of the trained model 272 such that certain output information may be generated more frequently or less frequently. The detail interface 390 may also include fields having information associated with each class record 402, such as a class precision field 404 (e.g., similar to the precision field 356), a class coverage field 406 (e.g., similar to the coverage field 406), and a distribution field 408 (e.g., a quantity of paired training data 254).

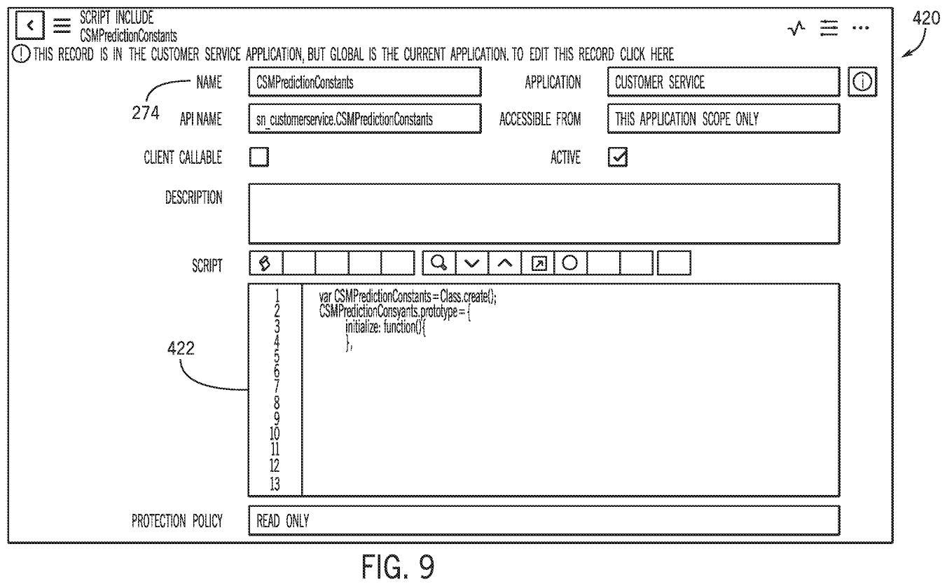

FIG. 9 illustrates an embodiment of a script interface 420 that may be accessed by the designer, in which the designer may use the script interface 420 in addition to or as an alternative to the definition interface 270, the configuration interface 350, and/or the details interface 390 to configure the case management application. The script interface 420 may include certain fields, such as fields associated with a name, application, description, and the like, associated with the case management application. Moreover, the script interface 420 may include a script 422 that the designer may modify to configure which paired training data 254 is accessed by the case management application. By way of example, the designer may modify software code in the script 422 to select which trained models 272 and/or class records 402 are active.

FIGS. 6-9 primarily describe a designer selecting the trained model 272 to be accessed by the case management application to identify output information. However, it should be noted that in additional or alternative embodiments, the case management application may automatically determine which trained models 272 are to be accessed. For example, the case management application may selectively access trained models 272 based on a characteristic of the service case (e.g., a related topic or category). As such, the case management application may be customized or configured for each service case.

In further embodiments, the designer may create different versions of the case management application. As an example, the designer may create a first version of the case management application, in which the case management application may access a first set of trained models 272. The designer may also create a second version of the case management application, in which the case management application may access a second set of trained models 272 that are different than the first set of trained models 272. The designer may also determine when a particular version of the case management application may be in effect. By way of example, the designer may designate that different groups of users (e.g., based on geographic location, degree of experience, job title) use different versions of the case management application. In this manner, the designer does not have to reconfigure the case management application for different implementations.

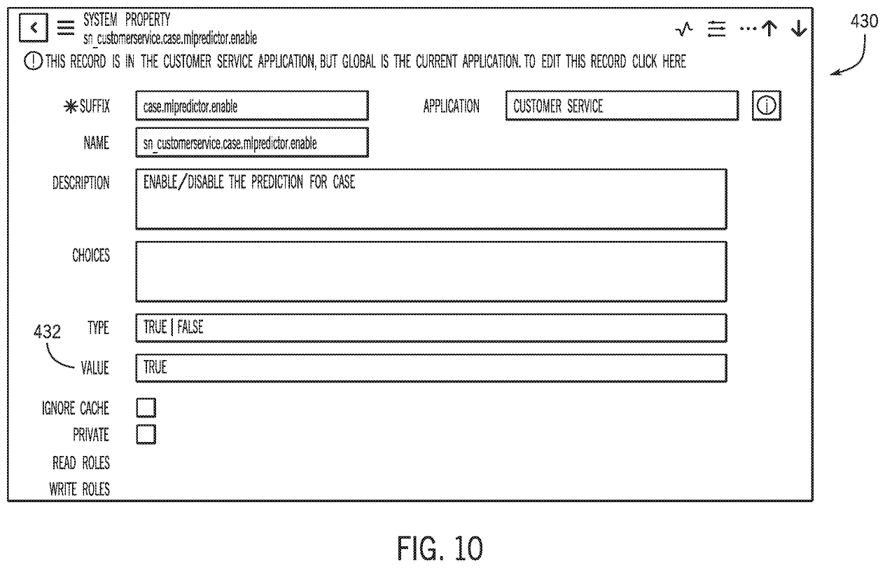

FIG. 10 illustrates an embodiment of a property interface 430 that may also be accessed by the designer and be used to configure the case management application. In some embodiments, the designer may use the property interface 430 to enable or disable the case management application to populate fields with output information. For example, the designer may use the property interface 430 to block the case management application from accessing any of the trained models 272 such that none of the fields may be populated with output information. By way of example, the property interface 430 may include a value field 432, in which the user may enter a value into the value field 432 to enable or disable the case management application to populate fields with output information. By way of example, the user may enter “true” in the value field 432 to enable the case management application to access the trained models 272 and automatically populate fields with output information. In addition, the user may enter “false” in the value field 432 to disable the case management application from accessing the trained models 272 such that none of the fields are automatically filled or populated with output information. In additional or alternative embodiments, the property interface 430 may have a different feature that may be used by the designer to configure the case management application, such as a check box or radio button, a selectable icon, and the like, to enable or disable the case management application to generate output information.

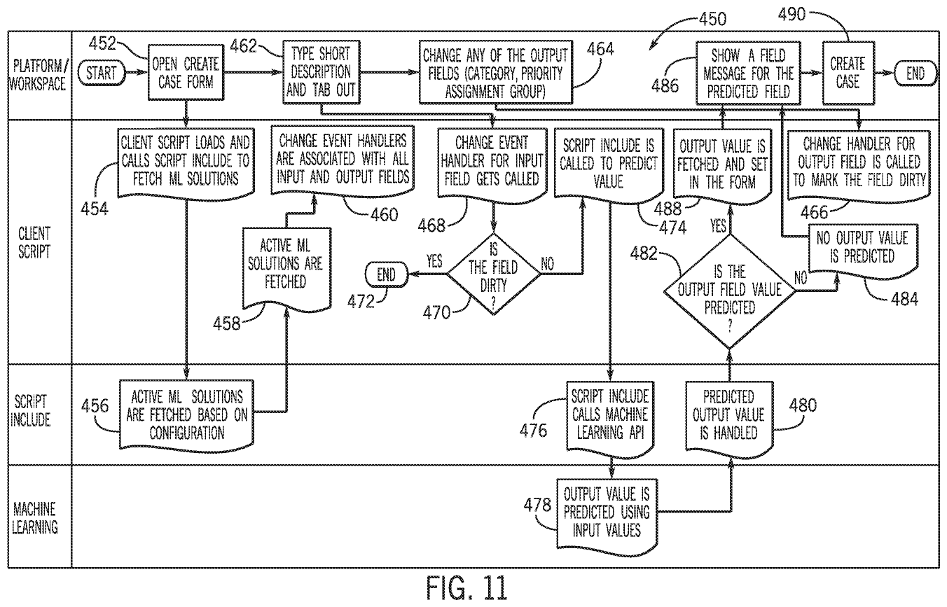

FIG. 11 illustrates an embodiment of a method or process 450 showing how the case management application may access trained models 272 or machine learning solutions to generate output information based on input information. At block 452, a new service case is opened, such as by a user of the case management application via a user interface (e.g., on the client device 20). When the new service case opens, the script (e.g., the script 422) associated with the case management application may load and initiate, as indicated by block 454. That is, a portion of the script (e.g., a script include or a script logic configured to fetch trained models 272), is executed to access the corresponding trained models 272 based on a configuration of the case management application, as shown at block 456. For example, the case management application may access trained models 272 based on the configuration of the software code of the script 422, the configuration of the definition interface 270, the configuration of the configuration interface 350, the configuration of the detail interface 390, and so forth, that may indicate which trained models 272 are active. At block 458, the trained models 272 that are indicated as active by the configuration of the case management application are successfully loaded. As a result of loading the trained models 272, certain event handlers that may be executed by the script 422 of the case management application may be adjusted, as indicated at block 460. That is, operation of the case management application may change such that a particular event (e.g., a received input information) may trigger a certain action (e.g., generating output information).

Referring back to block 452, after the user opens the service case, the user may enter input information, which includes typed information associated with the short description of the service case, as shown at block 462. In some circumstances, the user may enter and/or may have entered other input information, such as information associated with a category, priority, and/or assignment of the service case, as indicated by block 464. In response, at block 466, the field(s) in which the user enters information may be marked as “dirty”. For example, a change handler of the script 422 may be executed to mark the relevant field(s) as dirty.

Referring back to block 462, after the user enters the input information (e.g., tabs out or otherwise submits the input information) in the short description, the change handler of the script 422 may be executed to evaluate or process the input information, as indicated at block 468. By way of example, at block 470, the script 422 may determine if any of the fields associated with the potential output information (e.g., category, priority, assignment) have been marked as dirty (e.g., by the change handler at block 466). For the fields that have been marked as dirty, the script 422 may not perform any actions on the fields that have been marked as dirty, as shown at block 472. That is, the script 422 may not populate the fields with output information, because the fields have been previously defined by the user. However, if the script 422 determines the fields have not been marked as dirty, another portion of the script may be executed to identify output information to populate the fields, as indicated at block 474.

At block 476, the script 422 may identify a relevant trained models 272 that may be used to identify output information based on entered input information. At block 478, the relevant trained models 272 may identify an output information based on the input information. As an example, the relevant trained models 272 may determine that 90% of the paired data 254 having a particular keyword or phrase included in the input information may correspond with the same priority. As such, the relevant trained models 272 may predict or identify the same priority for the entered input information. In some circumstances, no output information may be identified by the relevant trained models 272. As such, the relevant trained models 272 may indicate that there is no identified output information.

At block 480, the script 422 may receive the identified output information, which may include an indication that no output information was identified. Then, at block 482, the script 422 determines if identified output information exists. For example, if the script 422 determines that no identified output information exists (e.g., the script 422 received an indication that no output information as identified), the script 422 may determine that no output information was identified or predicted. In response, the script 422 may indicate on the user interface (e.g., via a message) that no output information was identified for the associated field, as indicated at block 486. Thus, the user may be informed that no output information was automatically generated for the associated field, and may manually enter information. However, if the script 422 determines that identified output information exists, the script 422 may automatically populate the associated field with the identified output information, as shown at block 488. Additionally, at block 486, the script 422 may indicate on the user interface (e.g., via another message) that the associated field was populated with the identified output information. After the desired information associated with the opened service case has been entered manually by the user and/or automatically by the case management application, the user may finalize and create the service case, as shown at block 490.

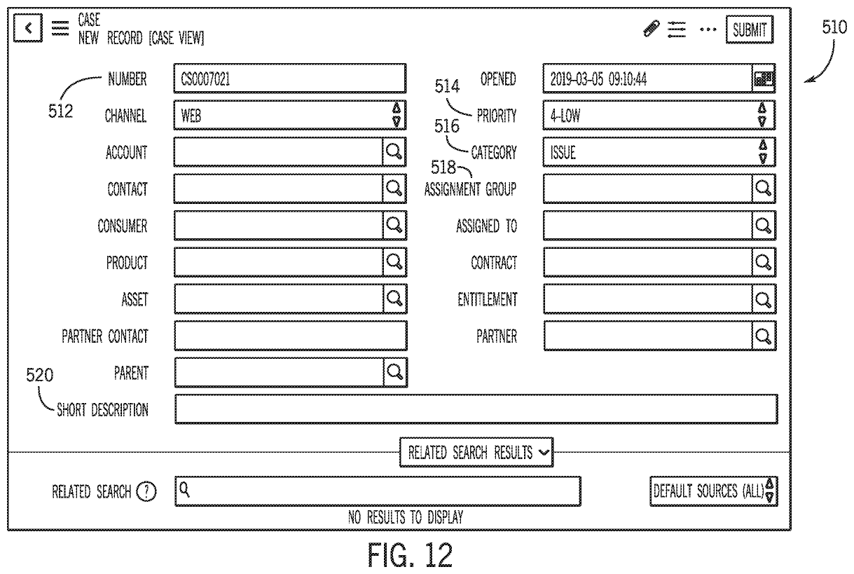

FIG. 12 illustrates an embodiment of a user interface 510 that may be accessed by a user of the case management application. The user interface 510 may be initialized upon an indication to open a service case, and the user interface 510 may be used to enter information associated with the service case. In some embodiments, the user interface 510 includes a plurality of fields in which the user may enter information. In the illustrated embodiment, the user interface 510 includes a number field 512 that contains information used to identify the case, a priority field 514 that includes information associated with an urgency and/or importance associated with the case, a category field 516 that includes information associated with a type of issue to which the case is classified, and an assignment field 518 associated with a topic or subject matter associated with the case. Moreover, the user interface 510 includes a short description field 520 pertaining to certain information that may describe or summarize the case. Additionally or alternatively, the user interface 510 may include other fields in which the user may enter information.

The case management application may be configured to automatically enter output information into certain fields on the user interface 510 based on input information entered by the user into one of the fields. As primarily described herein, the case management application may be configured to generate output information to fill the priority field, category field 516, and assignment field 518 based on input information entered by the user in the short description field 520. However, it should be noted that in additional or alternative embodiments, the case management application may be configured to generate output information in other fields and/or may identify output information based on input information entered in other fields.

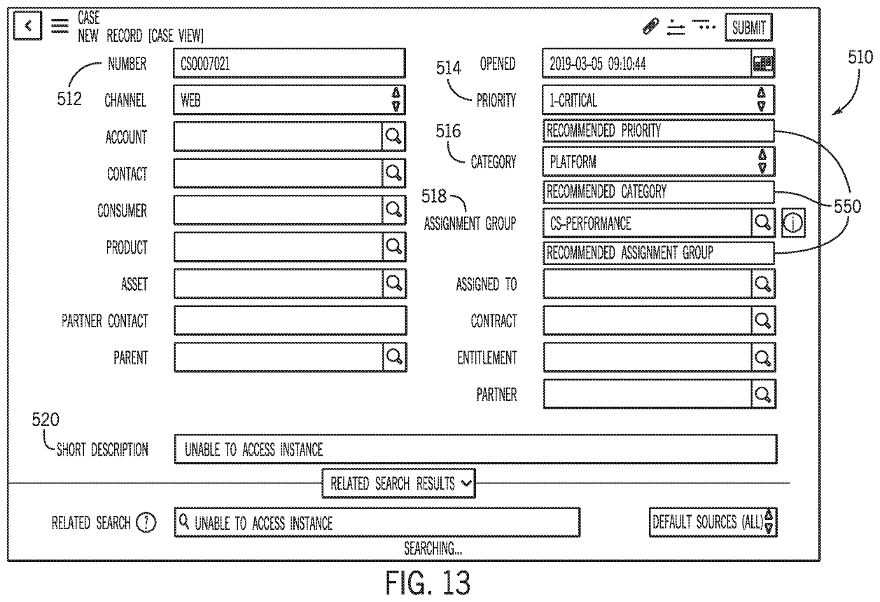

FIG. 13 illustrates an embodiment of the user interface 510 that may be accessed by the user, in which the user has entered input information into the short description field 520. In the illustrated example, the input information includes typed words and phrases. Based on the input information, the case management application may automatically enter output information in the priority field 514, category field 516, and assignment field 518. That is, the case management application may use the typed words and phrases of the input information to identify, via accessible trained models 272, corresponding output information associated with the priority field 514, category field 516, and assignment field 518.

Moreover, the user interface 510 may display a first type of message 550 indicating that the output information is recommended or identified by the case management application based on the input information. The first type of message 550 may inform the user which fields have been automatically populated. As shown in FIG. 13, a respective first type of message 550 may be displayed with each field that has been automatically populated with identified output information. Moreover, the first type of message 550 may not be displayed with fields that have not been filled with identified output information. In the illustrated embodiment, one version of the first type of message 550 may be associated with the priority field 514, another version of the first type of message 550 may be associated with the category field 516, and a further version of the first type of message 550 may be associated with the assignment field 518. As such, the user may easily identify the particular fields that include identified output information.

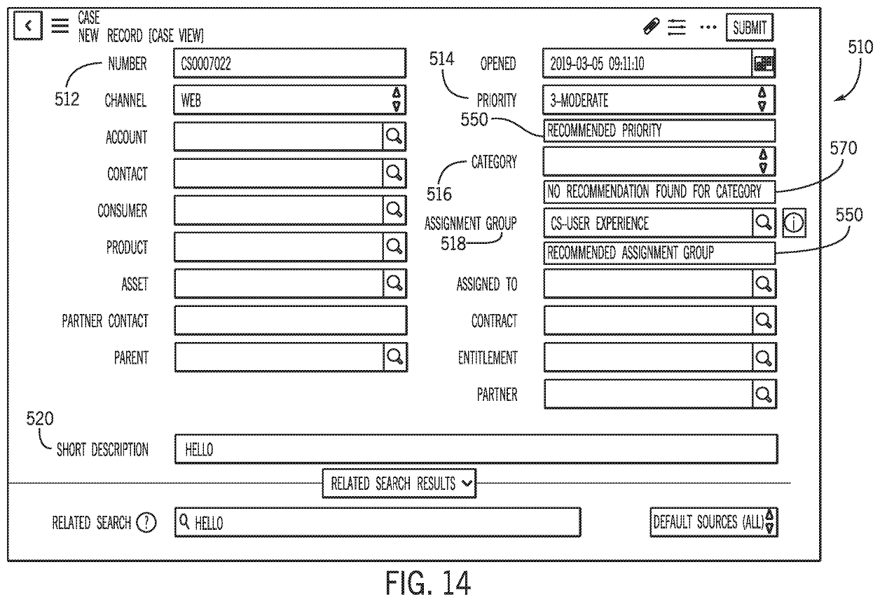

FIG. 14 illustrates an embodiment of the user interface 510 that may be accessed by the user, in which the user has entered input information into the short description field 520 but no output information was identified for one of the fields. In the illustrated example, output information is identified for the priority field 514 and the assignment field 518, and, thus, the first type of message 550 is displayed for the priority field 514 and the assignment field 518. However, output information may not have been identified for the category field 516. As such, a second type of message 570 may be displayed for the category field 516. The second type of message 570 may indicate that no output information has been identified for the associated field to inform the user that certain fields are to be manually filled by the user.

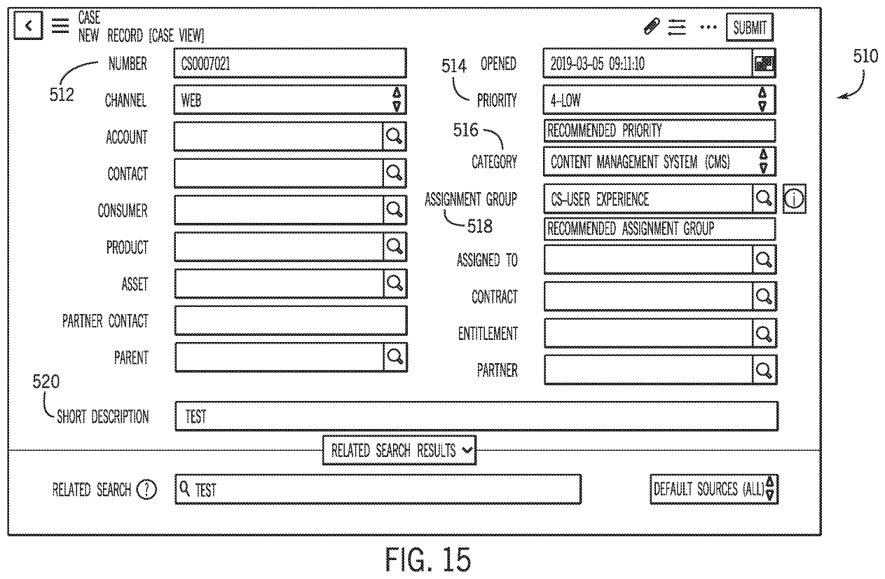

FIG. 15 illustrates an embodiment of the user interface 510 that may be accessed by the user, in which the user has entered input information into the short description field 520, but the case management application did not automatically populate one of the fields with output information. As mentioned herein, with reference to block 472 of FIG. 11, the case management application may not perform any actions, such as identifying output information, in fields that have been marked as dirty. In other words, if the case management application determines that a field has already been filled with information by the user, the case management application may not override such information with identified output information. Instead, the case management application may leave the field with the information filled by the user.

In some embodiments, the case management application also may not provide output information for a particular field that previously had output information overridden by the user. For example, during a first opened case, the case management application may provide output information for the category field 516. However, the user may have manually changed and overridden the output information. As a result, in a second subsequently opened case, the case management application may no longer provide output information for the category field 516 such that the user may manually enter information for the category field 516.

The present disclosure is related to a case management application that may be used by a user to open service cases. The user may enter certain input information in a field of the service case and the case management application may automatically identify output information based on the input information. The case management application may then fill or populate other fields of the service case with the identified output information such that the user does not have to fill the fields manually, which may reduce an amount of time the user spends to create a service case. In some embodiments, the case management application may use trained machine learning routines to identify the output information based on input information. Moreover, a designer of the case management application may customize or configure the case management application. For example, the designer may select the trained machine learning routines that are accessed by the case management application to adjust how the case management application identifies output information.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A case management application comprising:
an interface displaying a plurality of fields, wherein each field of the plurality of fields is configured to receive information;
wherein the case management application is configured to:
receive input information entered into at least one field of the plurality of fields; and
in response to receiving input information, access at least one machine learning routine to identify output information to display in at least one other field of the plurality of fields based at least on the input information, wherein the at least one machine learning routine is specified from a plurality of machine learning routines.

2. The case management application of claim 1, wherein the input information comprises text input and wherein the case management application is configured to access the at least one machine learning routine to identify output information based at least on a keyword, phrase, or both of the text input.

3. The case management application of claim 1, wherein the at least one field of the plurality of fields comprises a short description field.

4. The case management application of claim 1, wherein the at least one other field of the plurality of fields comprises a priority field, a category field, an assignment field, or any combination thereof

5. The case management application of claim 1, wherein each machine learning routine of the plurality of machine learning routines is stored on a database.

6. The case management application of claim 1, wherein each machine learning routine of the plurality of machine learning routines is trained using paired training data.

7. A system, comprising:
one or more client instances hosted by a platform, wherein the one or more client instances support application and data access on one or more remote client networks, wherein the system is configured to perform, on a client device in communication with a respective client instance, operations comprising:
displaying an interface comprising a plurality of fields configured to receive inputs;
receiving input information entered into at least one field of the plurality of fields;
in response to receiving the input information, identifying output information associated with at least one other field of the plurality of fields based on the input information and at least one machine learning routine; and
displaying, at the associated at least one other field, the output information.

8. The system of claim 7, wherein the system is configured to perform operations comprising displaying, at the associated at least one other field, a message indicative of identifying the output information in response to displaying the output information.

9. The system of claim 7, wherein the system is configured to perform operations comprising receiving other input information to adjust or change the output information displayed at a selected field of the associated at least one other field.

10. The system of claim 9, wherein the system is configured to perform operations comprising:
displaying an additional interface comprising the plurality of fields;
receiving additional input information in at least one field of the plurality of fields;
in response to receiving the additional input information, identifying additional output information associated with at least one other additional field of the plurality of fields based on the additional input information and the at least one machine learning routine, wherein the at least one other additional field does not comprise the selected field of which the output information is adjusted; and
displaying, at the associated at least one other additional field, the additional output information.

11. The system of claim 7, wherein the system is configured to perform operations comprising identifying that no output information is associated with a particular field of the at least one other field based on the input information and the at least one machine learning routine.

12. The system of claim 11, wherein the system is configured to perform operations comprising displaying, at the particular field, a message indicative that no output information is identified in response to identifying that no output information is associated with the particular field.

13. The system of claim 7, wherein the system is configured to perform operations comprising:
determining a particular field of the plurality of fields includes information entered by a user; and
in response to determining the particular field of the plurality of fields includes information, identifying output information associated with at least one other field of the plurality of fields based on the input information and the at least one machine learning routine, wherein the at least one other field does not comprise the particular field.

14. A design application configured to customize a case management application, wherein the design application comprises:
a first interface displaying an option that is selectable to enable and disable access to at least one machine learning routine by the case management application to determine output information based on input information; and
a second interface providing information associated with the at least one machine learning routine, wherein the at least one machine learning routine is selectable from a plurality of machine learning routines.

15. The design application of claim 14, wherein the second interface provides information associated with each machine learning routine of the plurality of machine learning routines.

16. The design application of claim 15, wherein the information comprises a name field, a solution template field, a created field, a table field, an input field, an output field, an active field, a version field, a coverage field, a precision field, a class field, a row field, or any combination thereof.

17. The design application of claim 14, wherein the second interface displays an routine record associated with each machine learning routine of the plurality of machine learning routines, wherein each routine record is selectable, and wherein the design application comprises a third interface invoked in response to a selection of a selected routine, wherein the third interface displays additional information of a selected machine learning routine associated with the selected routine record.

18. The design application of claim 17, wherein the additional information comprises information associated with a plurality of paired data implemented to the selected machine learning routine, wherein the plurality of paired data associates a plurality of input information with a respective output information.

19. The design application of claim 17, wherein the additional information comprises a definition field, a progress field, a state field, and updated field, or any combination thereof.

20. The design application of claim 14, wherein the second interface displays a script, and wherein the script is adjustable to select the at least one machine learning routine.
